(19) United States
(12) Patent Application Publication
(10) Pub. No.: US 2004/0019885 A1
(43) Pub. Date: Jan. 29, 2004

(54) Performance monitoring

(75) Inventors: Ramesh Mandava, San Jose, CA (US); Prasad Subramanian, Sunnyvale, CA (US); Arun Gupta, San Jose, CA (US)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/206,745

(22) Filed: Jul. 26, 2002

(51) Int. Cl. G06F 9/45; G06F 9/44; G06F 15/00

(52) U.S. Cl. 717/158; 717/127; 715/513

(57) ABSTRACT

The monitoring of the performance of computer code may be accomplished by inserting starting and ending hooks in the computer code, the hooks indicating the start or end of a group, feature, or subfeature. These hooks may gather the time at which they are executed, and these values may be appended to an extensible markup language file. This file may then be utilized to gauge the performance of various portions of the computer code.

### FIELD OF THE INVENTION

The present invention relates to the field of computer software. More particularly, the present invention relates to the monitoring of the execution of computer software.

### BACKGROUND OF THE INVENTION

Before newly created software technology is released to the public, it is tested for performance. This is done to ensure that the product released is as efficient as possible. Typically, software is tested by measuring the time it takes for execution. Thus, a measurement in time (e.g. a number of milliseconds) is produced by a testing module when the software is run. This, however, provides a fairly limited picture of the performance of the software. It does not allow for the monitoring of subportions within a software program, such as individual loops. It also does not provide a mechanism for viewing or comparing results in any meaningful way.

Another problem with these typical testing techniques is that they do not utilize a generic interface. This means that a completely new testing program must be designed for each language used by the programmer. Since it is common for programmers to be proficient in many different computer languages, and to even work in more than one computer language when designing a single software product, the fact that a new interface must be created for each language impairs efficiency.

### BRIEF DESCRIPTION OF THE INVENTION

The monitoring of the performance of computer code may be accomplished by inserting starting and ending hooks in the computer code, the hooks indicating the start or end of a group, feature, or subfeature. These hooks may gather the time at which they are executed, and these values may be appended to an extensible markup language file. This file may then be utilized to gauge the performance of various portions of the computer code.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the Drawings:

FIG. 1 is a diagram illustrating a sample code snippet in accordance with a specific embodiment of the present invention.

FIG. 2 is a diagram illustrating a sample code snippit with starting and ending hooks in accordance with a specific embodiment of the present invention.

FIG. 3 is a diagram illustrating a document type definition in accordance with a specific embodiment of the present invention.

FIG. 4 is a flow diagram illustrating a method for monitoring the performance of computer code in accordance with a specific embodiment of the present invention.

FIG. 5 is a flow diagram illustrating a method for gathering information regarding the performance of the execution of a computer program in accordance with a specific embodiment of the present invention.

FIG. 6 is a block diagram illustrating an apparatus for monitoring the performance of computer code in accordance with a specific embodiment of the present invention.

FIG. 7 is a block diagram illustrating an apparatus for gathering information regarding the performance of the execution of a computer program in accordance with a specific embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention utilizes an Extensible Markup Language (XML) to provide a generic framework for gathering and reporting results of tests on software. While the present application may use the term “XML”, one of ordinary skill in the art will recognize that any extensible markup language may be used. In the present invention, XML hooks are placed within the software code, such that when execution of the code occurs, the hooks gather the appropriate information regarding performance. Each hook may indicate the starting or ending of a particular group, feature, or subfeature. Groups may be divided into one or more features, and features may be divided into one or more subfeatures. Additionally, each subfeature may also be divided further into subfeatures. Thus, a nesting may occur where a hierarchy can be defined with fine granularity. This provides a common, practical output for software testing and works across multiple platforms.

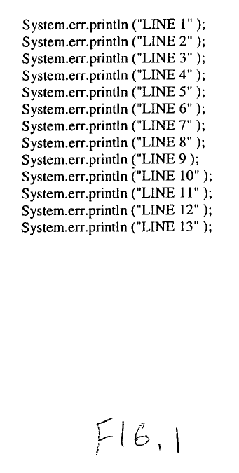

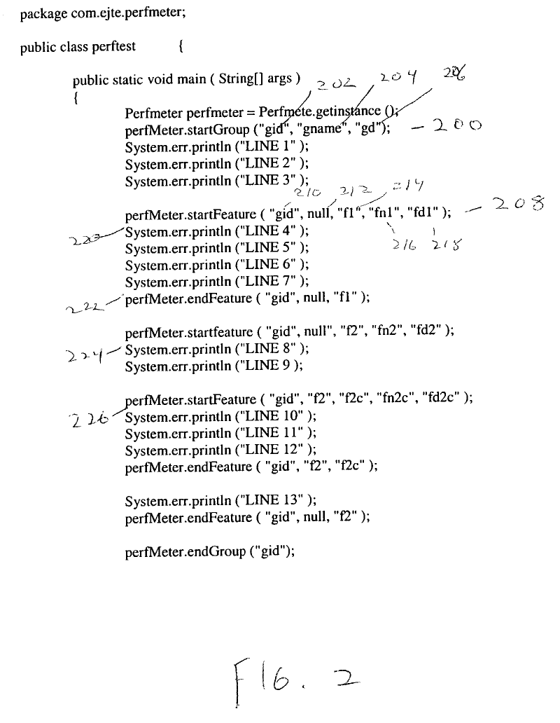

FIG. 1 is a diagram illustrating a sample code snippet in accordance with a specific embodiment of the present invention. This example is written in the Java™ programming language created by Sun Microsystems of Palo Alto, Calif. One of ordinary skill in the art will recognize, however, that the code snippet may be written in any programming language. The programmer may want to designate this portion of code in the group “gname”, having features “f1” and “f2”, with “f2” having subfeature “f2c”. Thus, the programmer may place starting and ending hooks in the code as illustrated in FIG. 2. A startgroup hook 200 is placed at the beginning of the gname group. A group id “gid” 202 may be specified as well as group name “gname” 204 and group description “gd” 206 . Within the group, a startfeature hook 208 is placed at the beginning of the first feature. A group ID “gid” 210 is specified, as well as a parent feature 212 (here, null, as there is no parent feature). A feature ID “fn1” 214 may be specified, as well as a feature name “fn1” 216 and feature description “fd1” 218.

The hierarchy may be defined by how the groups, features, and subfeatures are nested. For example, f1 begins at 220 and ends at 222. But f2 begins at 224 and subfeature f2c begins at 226 before f2 ends. Thus, f2c is a subfeature of feature f2. The hierarchy may also be defined by using the parent parameter to indicate a subfeature's parent.

In a specific embodiment of the present invention, the framework may take the form of an application program interface (API) containing procedures used to implement the hooks. A start group command may be used for starting a new logical group. Parameters to the start group command may include a group identification, a group name, and a group description. The start group command may store this information in a hash table. The start group command may also record the time that the start group command is executed in a vector. An end group command may be used for ending a logical group. A parameter to the end group command may be a group identification. The end group command may record the time that the end group command is executed in a vector. Additionally, a parameter mentioning whether to flush performance measure information now may be added to the end group command. Flushing prepares and outputs an XML representation of the class' content for the given group identification. Thus, the end group command may call the flushing command. The flushing command may retrieve the group, feature, and subfeature information from the hash table entry corresponding to the group identification. It may also retrieve the time stamp information from the appropriate vectors. It then may append all of it to an extensible markup language file. A document type definition (DTD) may be utilized, which indicates the format for reporting performance test results. Thus, the flush command may serialize all pertinant data from random access memory (RAM) to the extensible markup language file.

A start feature command may be used to start a new feature or subfeature inside a logical group. Parameters to start feature may include a group identification, a parent identification, a feature identification, a feature name, and a feature description. The start feature command may also record the time that the start feature command is executed in a vector. An end feature command may be used for ending a feature or subfeature inside a logical group. Parameters to the end feature command may include a group identification, a parent identification, and a feature identification. The end feature command may record the time that the end feature command is executed in a vector.

Additionally, a flush all command may be provided which flushes all remaining information to the XML file. This may be used if one or more of the groups were not flushed using the end group command. Furthermore, a shutdown hook may be utilized to call the flush all command when the execution of the program is interrupted unexpectedly, such as if the virtual machine shuts down in the middle of execution.

Once the information is in the extensible markup language file, one or more stylesheets may be applied to the file to generate the preferred report format. Various metrics may be applied to the information within the file. For example, in addition to total running time for each group, feature, and subfeature, averages and standard deviations may be calculated and displayed. Additionally, information from one execution may be compared against information from another execution. Graphs, tables, or other graphics may be computed and displayed as well.

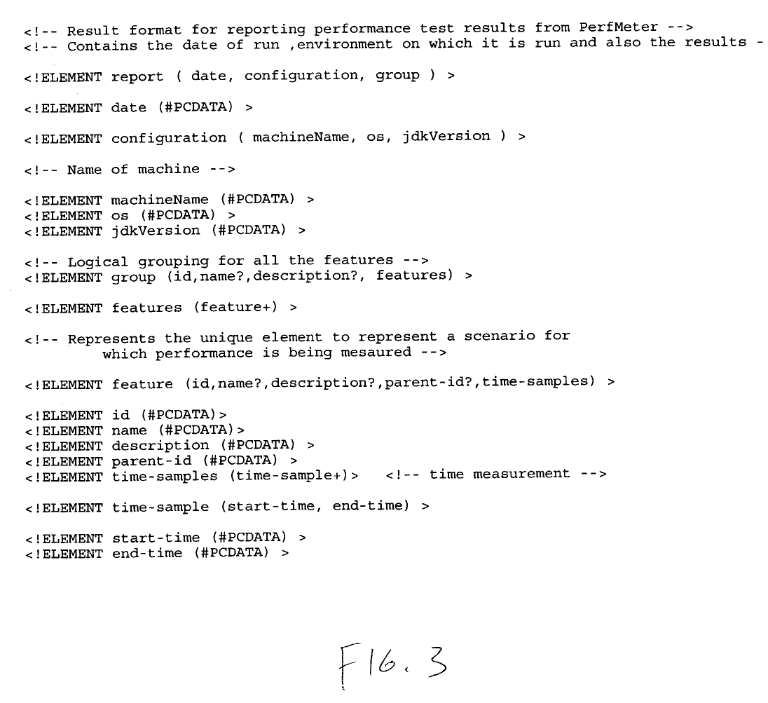

FIG. 3 is a diagram illustrating a document type definition in accordance with a specific embodiment of the present invention. Start-time and end-time 300, 302 may store the time stamps and may be sub elements of time-sample 304, which may be a sub element of time-samples. These may all be stored after basic information regarding the group, feature, or subfeature 306.

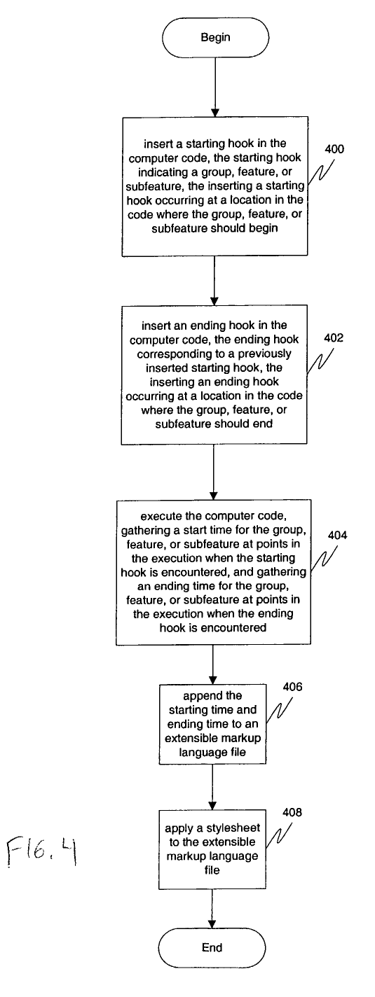

FIG. 4 is a flow diagram illustrating a method for monitoring the performance of computer code in accordance with a specific embodiment of the present invention. At 400, a starting hook is inserted in the computer code, the starting hook indicating a group, feature, or subfeature, the inserting a starting hook occurring at a location in the code where the group, feature, or subfeature should begin. A group may be divided into features, and a feature may be divided into subfeatures. If the starting hook indicates a subfeature, it may also indicate a parent feature or subfeature for the subfeature. Alternatively, the parent of a subfeature may be inferred if the starting hook for the subfeature is inserted between a starting hook and an ending hook for a different group, feature, or subfeature. At 402, an ending hook is inserted in the computer code, the ending hook corresponding to a previously inserted starting hook, the inserting an ending hook occurring at a location in the code where the group, feature, or subfeature should end. At 404, the computer code is executed, gathering a start time for the group, feature, or subfeature at points in the execution when said starting hook is encountered, and gathering an ending time for the group, feature, or subfeature at points in the execution when the ending hook is encountered. At 406, the starting time and ending time may be appended to an extensible markup language file. This may be done in accordance with a document type definition. At 408, a stylesheet may be applied to the extensible markup language file. This stylesheet may define the format of the report and also may indicate one or more calculations to be performed on the starting and ending time information, such as finding the difference between the times, performing averaging or standard deviation calculating, or comparing two different executions.

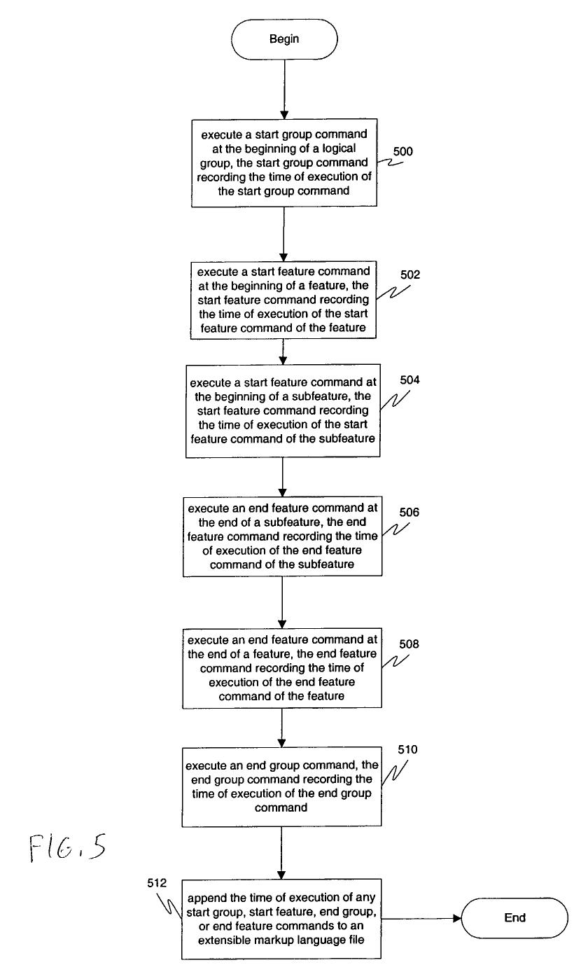

FIG. 5 is a flow diagram illustrating a method for gathering information regarding the performance of the execution of a computer program in accordance with a specific embodiment of the present invention. At 500, a start group command may be executed at the beginning of a logical group, the start group command recording the time of execution of the start group command. At 502, a start feature command may be executed at the beginning of a feature, the start feature command recording the time of execution of the start feature command for the fealure. At 504, a start feature command may be executed at the beginning of a subfeature, the start feature command recording the time of execution of the start feature command for the subfeature. At 506, an end feature command may be executed at the end of the subfeature, the end feature command recording the time of execution of the end feature command for the subfeature. At 508, an end feature command may be executed at the end of the feature, the end feature command recording the time of execution of the end feature command for the feature. At 510, an end group command may be executed at the ending of a logical group, the end group command recording the time of execution of the end group command. At 512, the time of execution of any start group, start feature, end group, or end feature commands may be appended to an extensible markup language file.

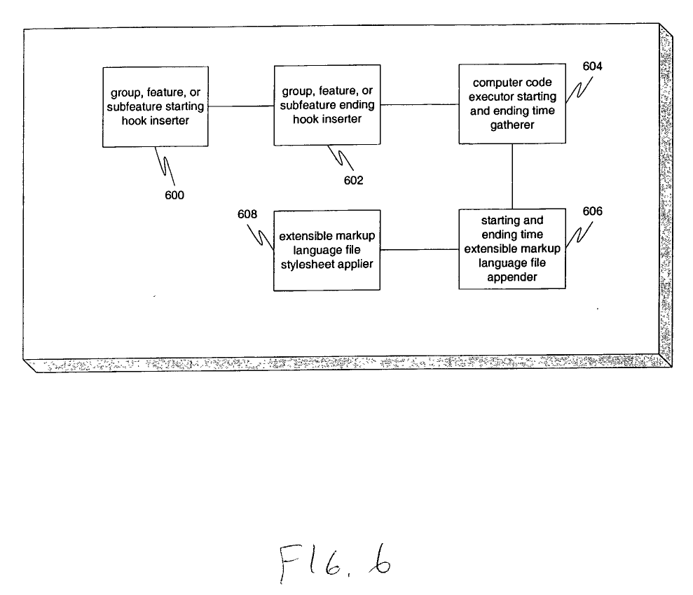

FIG. 6 is a block diagram illustrating an apparatus for monitoring the performance of computer code in accordance with a specific embodiment of the present invention. A group, feature, or subfeature starting hook inserter 600 inserts a starting hook in the computer code, the starting hook indicating a group, feature, or subfeature, the inserting a starting hook occurring at a location in the code where the group, feature, or subfeature should begin. A group may be divided into features, and a feature may be divided into subfeatures. If the starting hook indicates a subfeature, it may also indicate a parent feature or subfeature for the subfeature. Alternatively, the parent of a subfeature may be inferred if the starting hook for the subfeature is inserted between a starting hook and an ending hook for a different group, feature, or subfeature. A group, feature, or subfeature ending hook inserter 602 coupled to the group, feature, or subfeature starting hook inserter 600 inserts an ending hook in the computer code, the ending hook corresponding to a previously inserted starting hook, the inserting an ending hook occurring at a location in the code where the group, feature, or subfeature should end. A computer code executor starting and ending time gatherer 604 coupled to the group, feature, or subfeature ending hook inserter 602 executes the computer code, gathering a start time for the group, feature, or subfeature at points in the execution when said starting hook is encountered, and gathering an ending time for the group, feature, or subfeature at points in the execution when the ending hook is encountered. A starting and ending time extensible markup language file appender 606 coupled to the computer code executor starting and ending time gatherer 604 may append the starting time and ending time to an extensible markup language file. This may be done in accordance with a document type definition. An extensible markup language file stylesheet applier 608 coupled to the starting and ending time extensible markup language file appender 606 may apply a stylesheet to the extensible markup language file. This stylesheet may define the format of the report and also may indicate one or more calculations to be performed on the starting and ending time information, such as finding the difference between the times, performing averaging or standard deviation calculating, or comparing two different executions.

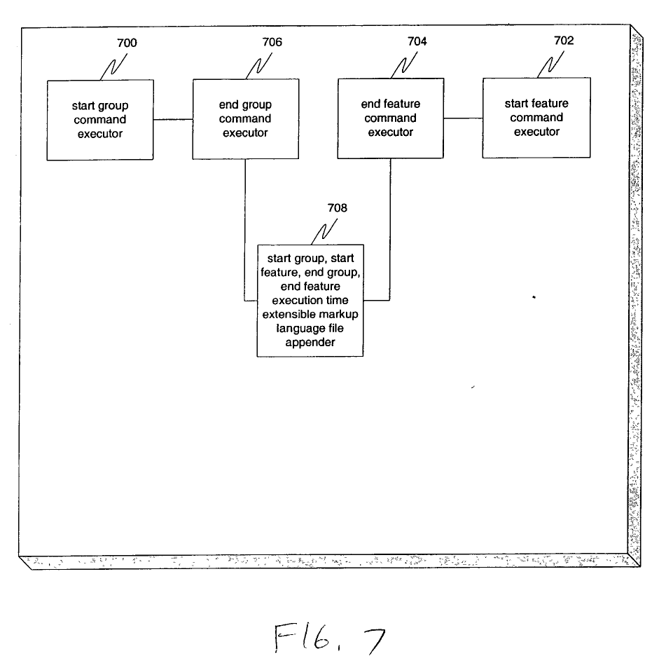

FIG. 7 is a block diagram illustrating an apparatus for gathering information regarding the performance of the execution of a computer program in accordance with a specific embodiment of the present invention. A start group command executor 700 may execute a start group command at the beginning of a logical group, the start group command recording the time of execution of the start group command. A start feature command executor 702 may execute a start feature command at the beginning of a feature, the start feature command recording the time of execution of the start feature command for the feature. The start feature command executor 702 may also execute a start feature command at the beginning of a subfeature, the start feature command recording the time of execution of the start feature command for the subfeature. An end feature command executor 704 coupled to the start feature command executor 702 may execute an end feature command at the end of the subfeature, the end feature command recording the time of execution of the end feature command for the subfeature. The end feature command executor 704 may also execute an end feature command at the end of the feature, the end feature command recording the time of execution of the end feature command for the feature. An end group command executor 706 coupled to the start group command executor 700 may execute an end group command may be executed at the ending of a logical group, the end group command recording the time of execution of the end group command. A start group, start feature, end group, end feature execution time extensible markup language file appender 708 coupled to the end group command executor 706 and to the end feature command executor 704 appends the time of execution of any start group, start feature, end group, or end feature commands to an extensible markup language file.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims. CLAIMS

What is claimed is:

1. A method for monitoring the performance of computer code, comprising:
inserting a starting hook in the computer code, said starting hook indicating a group, feature, or subfeature, said inserting a starting hook occurring at a location in the code where the group, feature, or subfeature should begin;
inserting an ending hook in the computer code, said ending hook corresponding to a previously inserted starting hook, said inserting an ending hook occurring at a location in the code where the group, feature, or subfeature should end; and
executing said computer code, gathering a start time for said group, feature, or subfeature at points in said execution when said starting hook is encountered, and gathering an ending time for said group, feature, or subfeature at points in said execution when said ending hook is encountered.

2. The method of claim 1, wherein at least one of said groups comprises one or more features.

3. The method of claim 1, wherein at least one of said features comprises one or more subfeatures.

4. The method of claim 3, wherein at least one of said subfeatures is comprised of one or more subfeatures.

5. The method of claim 1, wherein if said starting hook indicates a subfeature, said starting hook also indicates a parent feature or subfeature for said subfeature.

6. The method of claim 1, wherein if said starting hook for a particular group, feature, or subfeature is inserted between a starting hook and an ending hook for a different group, feature, or subfeature, then said different group, feature, or subfeature is a parent to said particular group, feature, or subfeature.

7. The method of claim 1, further comprising appending said starting time and ending time to an extensible markup language file.

8. The method of claim 7, wherein said appending comprises appending said starting time and ending time to an extensible markup language file in accordance with a document type definition.

9. The method of claim 8, further comprising applying a stylesheet to said extensible markup language file.

10. A method for gathering information regarding the performance of the execution of a computer program, the method comprising:
executing a start group command at the beginning of a logical group, said start group command recording the time of execution of said start group command;
executing an end group command at the ending of a logical group, said end group command recording the time of execution of the end group command;
appending said time of execution of said start group command and said time of execution of said end group command to an extensible markup language file.

11. The method of claim 10, further comprising:
executing a start feature command at the beginning of a feature, after said executing a start group command and before said executing an end group command, said start feature command recording the time of execution of the start feature command for said feature; and
executing an end feature command at the ending of said feature, after said executing a start group command and before said executing an end group command, said end feature command recording the time of execution of the start feature command for said feature.

12. The method of claim 11, wherein said appending further comprises appending said time of execution of said start feature command for said feature and said time of execution of said end feature command for said feature in an extensible markup language file.

13. The method of claim 12, further comprising:
executing a start feature command at the beginning of a subfeature, after said executing a start feature command and before said executing an end feature command, said start feature command recording the time of execution of the start feature command for said subfeature; and
executing an end feature command at the ending of said subfeature, after said executing a start feature command and before said executing an end feature command, said end feature command recording the time of execution of the start feature command for said subfeature.

14. The method of claim 13, wherein said appending further comprising appending said time of execution of said start feature command for said sub feature and said time of execution of said end feature command for said subfeature in an extensible markup language file.

15. An apparatus for monitoring the performance of computer code, comprising:
a group, feature, or subfeature starting hook inserter;
a group, feature, or subfeature ending hook inserter coupled to said group, feature, or subfeature starting hook inserter; and
a computer code executor starting and ending time gatherer coupled to said group, feature, or subfeature ending hook inserter.

16. The apparatus of claim 15, further comprising a starting and ending time extensible markup language file appender coupled to said computer code executor starting and ending time gatherer.

17. The apparatus of claim 16, further comprising an extensible markup language file stylesheet applier coupled to said starting and ending time extensible markup language file appender.

18. An apparatus for gathering information regarding the performance of the execution of a computer program, comprising:
a start group command executor;
a start feature command executor;
an end group command executor coupled to said start group command executor;
an end feature command executor coupled to said start feature command executor; and
a start group, start feature, end group, end feature execution time extensible markup language file appender coupled to said end group command executor and to said end feature command executor.

19. An apparatus for monitoring the performance of computer code, comprising:
means for inserting a starting hook in the computer code, said starting hook indicating a group, feature, or subfeature, said inserting a starting hook occurring at a location in the code where the group, feature, or subfeature should begin;
means for inserting an ending hook in the computer code, said ending hook corresponding to a previously inserted starting hook, said inserting an ending hook occurring at a location in the code where the group, feature, or subfeature should end; and
means for executing said computer code, gathering a start time for said group, feature, or subfeature at points in said execution when said starting hook is encountered, and gathering an ending time for said group, feature, or subfeature at points in said execution when said ending hook is encountered.

20. The apparatus of claim 19, wherein at least one of said groups comprises one or more features.

21. The apparatus of claim 19, wherein at least one of said features comprises one or more subfeatures.

22. The apparatus of claim 21, wherein at least one of said subfeatures is comprised of one or more subfeatures.

23. The apparatus of claim 19, wherein if said starting hook indicates a subfeature, said starting hook also indicates a parent feature or subfeature for said subfeature.

24. The apparatus of claim 19, wherein if said starting hook for a particular group, feature, or subfeature is inserted between a starting hook and an ending hook for a different group, feature, or subfeature, then said different group, feature, or subfeature is a parent to said particular group, feature, or subfeature.

25. The apparatus of claim 19, further comprising means for appending said starting time and ending time to an extensible markup language file.

26. The apparatus of claim 25, wherein said means for appending comprises means for appending said starting time and ending time to an extensible markup language file in accordance with a document type definition.

27. The apparatus of claim 26, further comprising means for applying a stylesheet to said extensible markup language file.

28. An apparatus for gathering information regarding the performance of the execution of a computer program, the apparatus comprising:
means for executing a start group command at the beginning of a logical group, said start group command recording the time of execution of said start group command;
means for executing an end group command at the ending of a logical group, said end group command recording the time of execution of the end group command;
means for appending said time of execution of said start group command and said time of execution of said end group command to an extensible markup language file.

29. The apparatus of claim 28, further comprising:
means for executing a start feature command at the beginning of a feature, after said executing a start group command and before said executing an end group command, said start feature command recording the time of execution of the start feature command for said feature; and
means for executing an end feature command at the ending of said feature, after said executing a start group command and before said executing an end group command, said end feature command recording the time of execution of the start feature command for said feature.

30. The apparatus of claim 29, wherein said means for appending further comprises means for appending said time of execution of said start feature command for said feature and said time of execution of said end feature command for said feature in an extensible markup language file.

31. The apparatus of claim 30, further comprising:
means for executing a start feature command at the beginning of a subfeature, after said executing a start feature command and before said executing an end feature command, said start feature command recording the time of execution of the start feature command for said subfeature; and
means for executing an end feature command at the ending of said subfeature, after said executing a start feature command and before said executing an end feature command, said end feature command recording the time of execution of the start feature command for said subfeature.

32. The apparatus of claim 31, wherein said means for appending further comprising means for appending said time of execution of said start feature command for said subfeature and said time of execution of said end feature command for said subfeature in an extensible markup language file.

33. A program storage device readable by a machine, tangibly embodying a program of instructions executable by the machine to perform a method for monitoring the performance of computer code, the method comprising:
inserting a starting hook in the computer code, said starting hook indicating a group, feature, or subfeature, said inserting a starting hook occurring at a location in the code where the group, feature, or subfeature should begin;
inserting an ending hook in the computer code, said ending hook corresponding to a previously inserted starting hook, said inserting an ending hook occurring at a location in the code where the group, feature, or subfeature should end; and
executing said computer code, gathering a start time for said group, feature, or subfeature at points in said execution when said starting hook is encountered, and gathering an ending time for said group, feature, or subfeature at points in said execution when said ending hook is encountered.

34. A program storage device readable by a machine, tangibly embodying a program of instructions executable by the machine to perform a method for gathering information regarding the performance of the execution of a computer program, the method comprising:
executing a start group command at the beginning of a logical group, said start group command recording the time of execution of said start group command;
executing an end group command at the ending of a logical group, said end group command recording the time of execution of the end group command;
appending said time of execution of said start group command and said time of execution of said end group command to an extensible markup language file.
